(19) United States
(12) Patent Application Publication
(10) Pub. No.: US 2004/0208494 A1
(43) Pub. Date: Oct. 21, 2004

(54) Data processing system and method, computer program product and audio/visual product

(76) Inventor: Stuart Antony Green, Sheffield (GB)

Correspondence Address: MYERS BIGEL SIBLEY & SAJOVEC, PO BOX 37428, RALEIGH, NC, 27627, US

(21) Appl. No.: 10/417,623

(22) Filed: Apr. 17, 2003

(51) Int. Cl. H04N 5/781

(52) U.S. Cl. 386/125; 386/126

(57) ABSTRACT

Embodiments of the present invention allow scrolling and/or zooming operations, comparable or substantially similar to those performed by a computer, to be realised and implemented using, for example, a conventional DVD and conventional DVD player.

### FIELD OF THE INVENTION

The present invention relates to a data processing system and method, a computer program product and an audio-visual product and, more particularly, to a DVD product authoring system and method, a computer program product for such an authoring system and method and a DVD product.

### BACKGROUND OF THE INVENTION

DVDs represent one of the fastest growing forms of multimedia entertainment throughout the world. Conventionally, DVDs have been used to present movies to users using extremely high quality digital audio/visual content. FIG. 1 shows, schematically, a typical home entertainment system 100 comprising a DVD player 102, a DVD 104 and a television 106. The DVD 104 contains a number of programs or cells 108 each of which comprises corresponding digital audio-visual content 110 together with respective navigation data 112. The navigation data 112 is used by a navigation engine 114 within the DVD player 102 to control the order or manner of presentation of the digital content 110 by a presentation engine 116. The presentation engine 116 presents the digital content 110 on the television 106 as rendered audio-visual content 118. As is well known within the art, the rendered audio-visual content 118, conventionally, takes the form a movie or photographic stills or text associated with that movie; so-called Bonus features.

A user (not shown) can use a remote control 120 associated with the DVD player 102 to influence the operation of the navigation engine 114 via an infrared remote control interface 122. The combination of the infrared remote control 120 and the navigation engine 114 allows the user to make various selections from any menus presented by the presentation engine 116 under the control of the navigation engine 114 as mentioned above.

FIG. 2 shows, schematically, a pair 200 of text screen stills that may represent text that can be stepped through by the user using their remote control 120. Typically, the screens stills would be merely two such stills of a number of stills. It can be appreciated that the first screen still 202 comprises a number of lines of text 204 together with forwards 206 and backwards 208 menu or arrow options. The forwards 206 and backwards 208 arrow or menu options allow the user, using their infrared remote control 120, to move to the previous text screen still or to the next text screen still. In the illustrated example, a second screen still 204 is displayed in response to the user selecting the forwards arrow 206 menu option. It can be appreciated that the second screen still also contains a body of text 210 and forwards 212 and backwards 214 arrow menu options.

Due to the relatively limited set of commands that might form the navigation data, the processing performed by the DVD player and, in particular, the navigation engine 114, is relatively simple and largely limited to responding to infrared remote control commands and retrieving and displaying, via the presentation engine 116, pre-authored or pre-determined digital audio-visual content 110. Beyond decoding and presenting the digital audio-visual content 110 as rendered A/V content 118, the DVD player 102 performs relatively little real-time processing.

This can be contrasted with the relatively sophisticated real-time processing performed by computers when presenting, for example, text documents such as those produced using Word available from Microsoft Corporation. FIG. 3 depicts, schematically, a display process 300 for displaying part 302 of a Word document 308 on a screen 304 of a computer system (not shown). The screen 304 conventionally also contains a scroll bar 306 that can be used to display other parts of the global Word document 308. The part 302 of the Word document currently displayed is determined by a “window” 310 that is capable of traversing the global Word document 308 to display various portions of that document 308 which are currently of interest to a user. The processing necessary for such scrolling through the text 312 of the document 308 is performed in real-time. Effectively, the microprocessor of the computer together with its instruction set is sufficiently sophisticated and flexible to imbue the Word application (not shown) with the capability to perform the necessary calculations and manipulations to implement scrolling of the Word document 308. It will be appreciated that each time the user scrolls to a different section of the global Word document 308, the part 302 of the Word document 308 shown on the screen 304 is updated, in real-time, in response to any scroll commands issued by the user.

It will be appreciated that this is in stark contrast to the display of text information via the DVD player 102 and the relatively crude or unsophisticated manner of stepping through that information as shown in FIG. 2. Current DVD players are unable to perform, in response to a user action or command, the real-time processing necessary to realise scrolling of data or images in a manner that is similar to that performed by computers. This is, primarily, due to the very limited instruction set that forms the navigation data that controls the presentation engine.

Similarly, computers can perform relatively sophisticated zooming operations in real-time. Varying levels of detail of a view of an image can be created as one zooms-in on or zooms-out from an image. Current DVD players are, again, unable to perform such real-time processing for implementing such zooming operations, especially in response to user actions or commands.

It is an object of embodiments of the present invention at least to mitigate some of the problems of the prior art.

### SUMMARY OF INVENTION

Accordingly, a first aspect of embodiments of the present invention provides a method of authoring visual content; the method comprising the steps of creating one or more video sequences comprising a set of visual assets having data derived from one or more original assets; the one or more video sequences representing a first, progressive, transition between a first view of the one or more original assets and a second view of the one or more original assets.

Advantageously, embodiments of the present invention allow scrolling and/or zooming of image data by a DVD player to be realised, that is, the embodiments allow the real-time scrolling and/or zooming performed by computers to be at least emulated.

Preferably, embodiments provide a method in which the step of creating comprises the step of deriving the data of the visual assets from the one or more original assets such that the one or more video sequences represent a first, progressive, transition from the first view of the one or more original assets to the second view of the one or more original assets.

Preferred embodiments also provide a method in which the step of creating comprises the step of deriving the data of the visual assets from the one or more original assets such that the one or more video sequences represent a first, progressive, transition from the second view of the one or more original assets to the first view of the one or more original assets.

Suitably, embodiments can be realised that provide a method in which the first, progressive, transition, between the first and second views of the one or more original assets represents a scrolling operation between those views. Therefore, scrolling between different views of a document can be emulated using, for example, a DVD player.

Preferred embodiments provide a method in which the step of creating comprises the step of deriving the data of the visual assets from the one or more original assets such that the one or more video sequences of the first, progressive, transition from the first view of the one or more original assets to the second view represents an expansion or contraction of the data of the one or more original assets. Suitably, zooming functions can be emulated using embodiments of the present invention.

Preferably, embodiments provide a method further comprising the step of creating for the one or more video sequences respective navigation data, responsive to a user command, to cause retrieval and output of the one or more video sequences. Still more preferably, embodiments provide a method in which the step of creating the navigation data comprises the step of creating one or more links between the one or more video sequences and a further video sequence to cause retrieval and output of the further video sequence before or after output of the one or more video sequences. Suitably, embodiments are provided that allow scrolling or zooming views to be related to one another.

Other aspects of embodiments of the present invention are described herein and claimed in the claims.

### BRIEF DESCRIPTION OF THE DRAWINGS

Embodiments of the present invention will now be described, by way of example only, with reference to the accompanying drawings in which:

FIG. 1 shows a home entertainment system;

FIG. 2 shows a pair of text screens;

FIG. 3 illustrates relatively sophisticated scrolling performed by a computer;

FIG. 4 shows, schematically, authoring of scrolling data sets according to an embodiment;

FIG. 5 illustrates the display of a number of scrolling data sets according to an embodiment;

FIG. 6 illustrates a flowchart for producing scrolling data sets;

FIG. 7 shows a flowchart for displaying digital A/V content using scrolling data sets;

FIG. 8 illustrates two-dimensional scrolling and the production of two-dimensional scrolling data sets; and

FIG. 9 depicts a process for producing video sequences representing, or emulating, zooming operations to produce expanded or contracted views of a document.

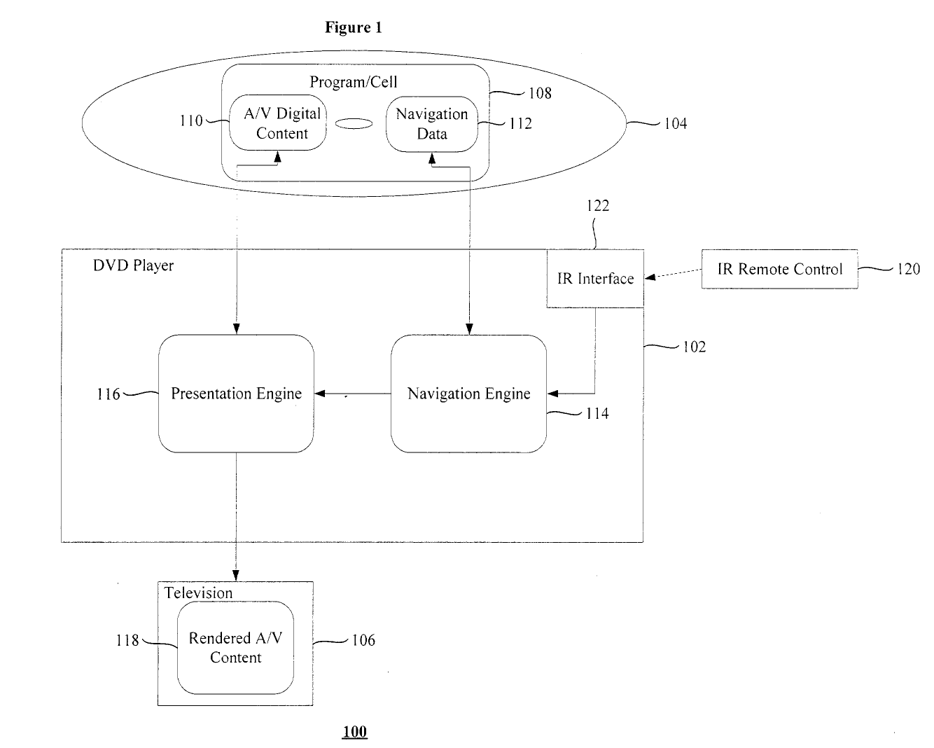

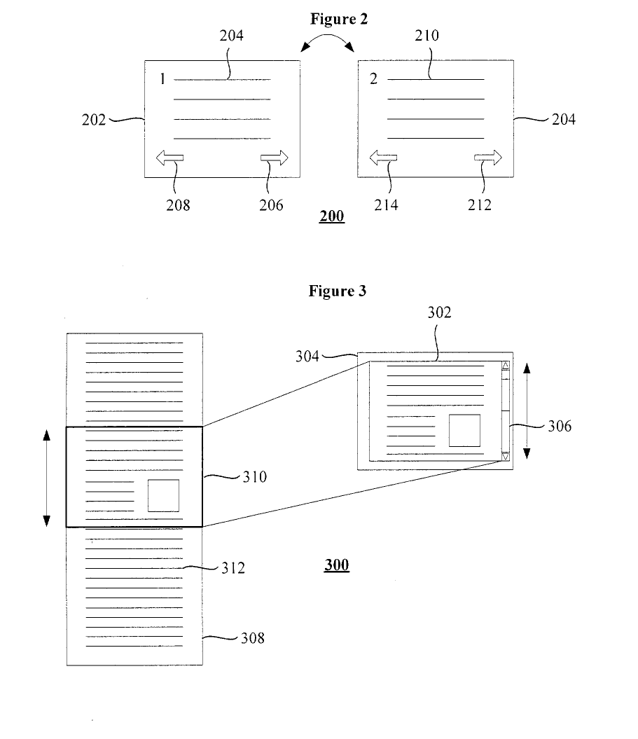

### DESCRIPTION OF PREFERRED EMBODIMENTS

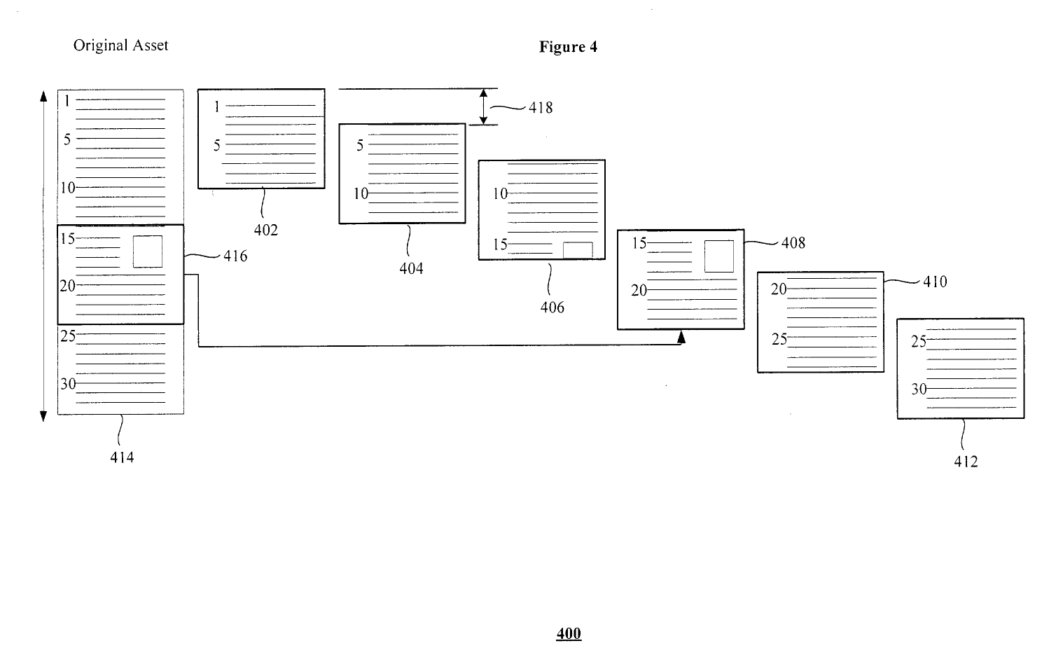

Referring to FIG. 4, there is shown schematically an authoring process 400 for producing one or more visual assets comprising a number of stills or frames 402 to 412 from a document 414 intended to be presented by the navigation engine 114 of a DVD player 102 in response to controls received from the infrared remote control 120. The stills 402 to 412 represent at least part of a set of visual assets for use in producing an optical medium based product, such as, for example, a DVD product. A moveable window 416 is arranged to traverse the document 414, according to a pre-defined step size 418, to produce each of the stills or frames 402 to 412. When each of the stills or frames 402 to 412 are retrieved and presented by the presentation engine 116 they will give the impression to the user of the DVD player 102 that the DVD player is scrolling through the document 414 in real-time, in response to a user command received from the remote control 120, even though no real-time processing comparable with that undertaken by a computer is performed. The data required to emulate such scrolling is pre-authored or pre-calculated, that is, it is determined in advance.

The document 414 represents an embodiment of an original visual asset. The original asset and/or a visual asset may comprise a static image, a dynamic image or sequences of images, that is, it might be, itself, a video sequence or a number of video sequences. A dynamic image comprises a visual asset for which the level of detail varies according to corresponding views of that asset. For example, the degree of detail of a dynamic document or image might increase or decrease as one zooms-in on or zooms-out from respective views of that document or image. Also, in one sense, a video sequence can be thought of as comprising a number of static or dynamic images.

It will be appreciated that as the step size 418 decreases, the smoothness of the result in scrolling increases.

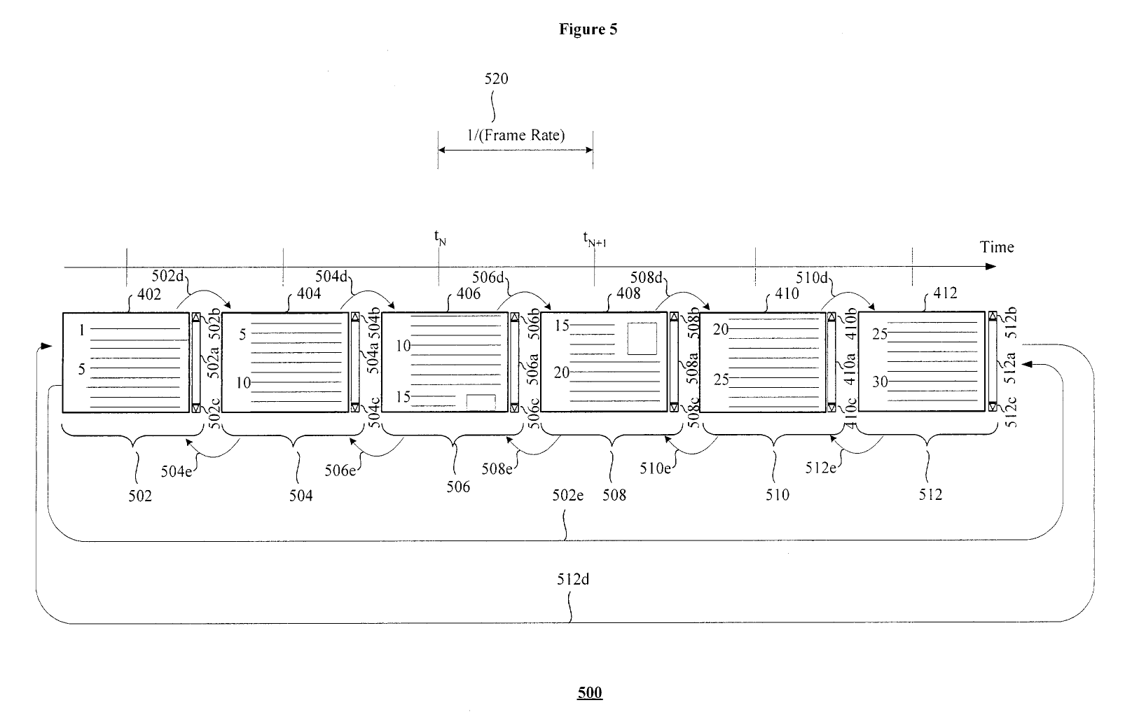

Each of the extracted stills or frames 402 to 412 are used to produce corresponding scrolling data sets 502 to 512 as shown in FIG. 5. For each scrolling data set 502 to 512, a scroll bar graphic 502a to 512a can also be produced. Each scroll bar graphic 502a to 512a comprises up arrow menu options 502b to 512b and down arrow menu options 502c to 512c that are recorded and presented as sub-picture data of the digital content 110. Associated with each scrolling data set 502 to 512 is corresponding navigation data that points to a preceding or succeeding still or frame 402 to 412. The corresponding navigation data used to retrieve a preceding or succeeding frame is determined according to which of the arrows 502b to 512b and 502c to 512c have been actuated or selected by the user using their remote control 120. The navigation data comprises a number of forward links 502d to 510d and a number of backward links 512e to 504e to allow the user to scroll through, that is, select, the various stills 402 to 412 represented by data recorded on the DVD 104. Once the user has reached a start or end screen such as, for example, stills 402 and 412 respectively, the sub-picture menu data can be arranged such that the stills 402 to 412 present a “wrapped-around” document. If an embodiment intends to present a “wrapped-around” document, corresponding navigation data 512d and 502e is required. Alternatively, the sub-picture menu data can be modified to indicate that one can only traverse forwards and backwards between the start 402 and end 412 stills by removing the backwards and forwards menu options from the start 402 and end 412 stills respectively.

Preferably, rather than producing arrow menu options on a frame-by-frame basis, embodiments can be realised that produce arrow menu options on a video sequence-by-video sequence basis, that is, a set of frames might have associated arrow menu options rather than each frame within the set having such arrow menu options.

It will be appreciated that each of the generated stills 402 to 412 represents, at least in part, transition data for giving effect to scrolling.

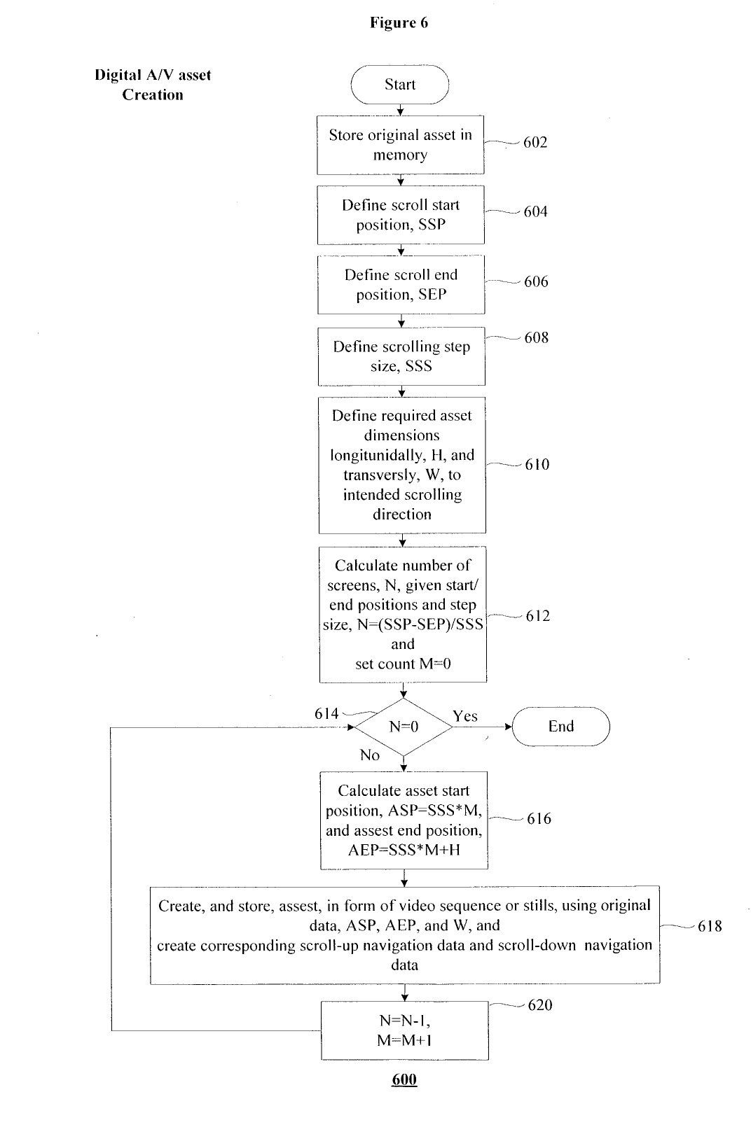

Referring to FIG. 6, there is shown a flowchart 600 of the processing involved in an authoring method according to an embodiment. The original asset such as, for example, the text document 414, is stored in memory (not shown) at step 602. A scroll start position, SSP, is defined in step 604. For example, in one embodiment the scroll start position may correspond to the first row of pixels of the scrolling window 416 when it is in a position that corresponds to still or frame 402. At step 606, a scroll end position, SEP, is defined. For example, in the first embodiment, the scroll end position might correspond to the first row of pixels defined by the window 416 when in a position corresponding to the last still or frame 412. However, in a second embodiment, the scroll end position might correspond to the first row of pixels of the window 416 when it is in a position corresponding to the second still or frame 404. The choice of which embodiment one skilled in the art realises depends upon the required scrolling smoothness or resolution.

A scrolling step size, SSS, is defined at step 608. The scrolling step size also influences the smoothness or resolution of any resulting scrolling. Longitudinal, H, and transverse, W, visual asset dimensions are defined at step 610. The number, N, of stills or frames required to give effect to scrolling between the scroll start position SSP, and the scroll end position, SEP, is calculated at step 612. Also, a count, M, that is used to keep track of the number of assets or frames produced so far, is set to zero at step 612.

A test is made, at step 614, to determine whether N=0. If it is determined that N is equal to zero, the visual asset creation process shown by the flowchart 600 is terminated. However, if it is determined that N is not equal to zero, the asset start position, ASP, and asset end position, AEP, are calculated at step 616. It will be appreciated that the longitudinal and transverse dimensions effectively correspond to the dimensions of the moveable window 416 used to produce the assets. At step 618, a current asset to be created is produced using the original data 414, the asset start position, the asset end position together with the window 416 or asset dimensions, H and W, and subsequently stored. Also created, at step 618, are the forwards navigation data 502d to 512d and backwards navigation data 512e to 502e and, optionally, the corresponding scroll bar graphics 502a to 512a. At step 620, the number, N, of screens or assets to be created is reduced by one and the count, M, is increased by one.

It will be appreciated that the flowchart 600 shown in FIG. 6 allows the data used in implementing or emulating the scrolling to be produced in advance and automatically. These pre-authored scrolling data sets can be used in the creation of a digital linear tape in preparation for producing the DVD product. It will be appreciated that each created asset 402 to 412 might be stored, on the resulting DVD product, as an MPEG sequence, which might be presented as a still image or as a video sequence.

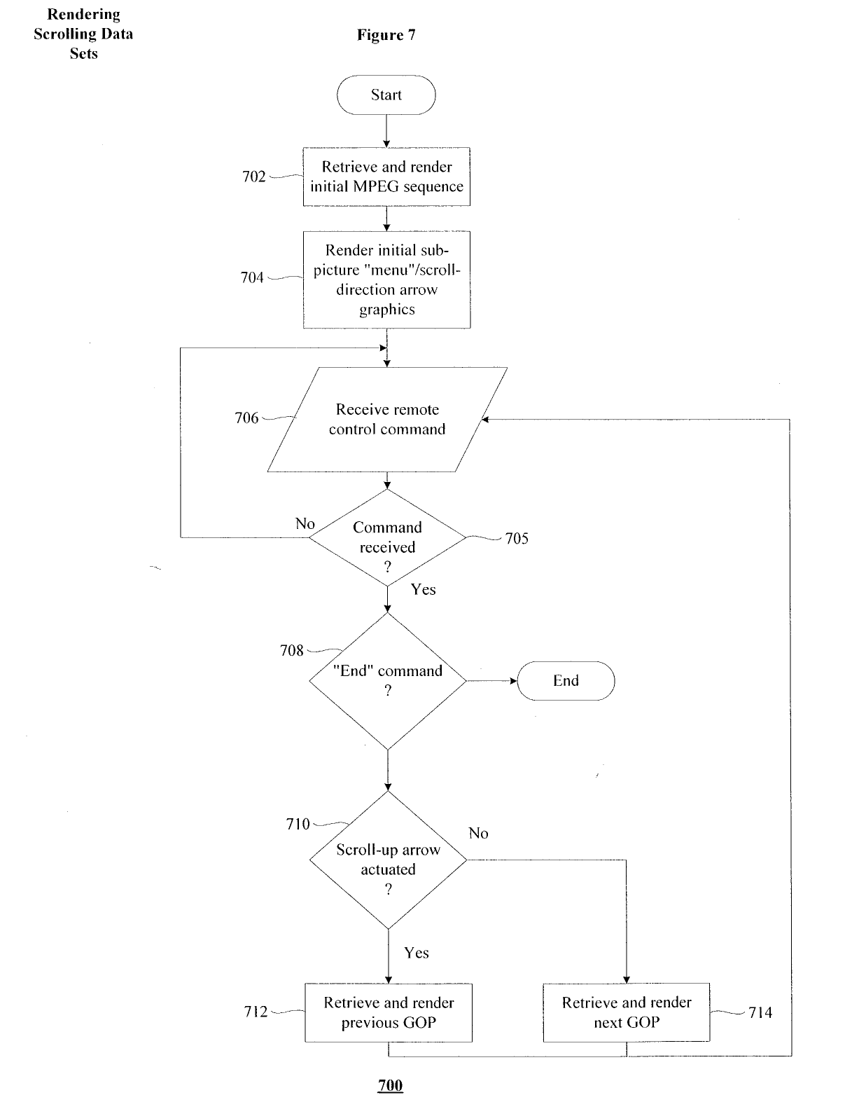

Referring to FIG. 7, there is shown a flowchart 700 for rendering the scrolling data sets 502 to 512. At step 702, the initial visual asset, that is, the initial MPEG sequence, is retrieved and rendered. Also, the optional initial sub-picture “menu” or scroll direction arrow graphics are retrieved and rendered at step 704. The navigation engine 114 then awaits receipt of a control command from the infrared remote control 120 at steps 705 and 706. It is determined, at step 708, whether the command is an “end” command. If the command is an “end” command, the process for rendering the scrolling data sets is terminated. It will be appreciated that within this context an “end” command represents a command that indicates a desire to perform processing or an activity other than continued scrolling. At step 710, it is determined whether the command represents a selection of the menu item represented by a scroll-up arrow and, therefore, represents actuation of the scroll-up arrow 502b to 512b. If it is determined, at step 710, that the scroll-up arrow has been actuated, the navigation engine 114, using the appropriate navigation data 512e to 502e, retrieves the “previous” or preceding video sequence, still or frame 402 to 412 at step 712. However, if it is determined that the scroll-up arrow has not been actuated, it is assumed that the scroll-down arrow has been actuated and the next or succeeding video sequence, still or frame 402 to 412 is retrieved and rendered at step 714. Processing then returns to step 705.

One skilled in the art will appreciate that the presentation of the scrolling arrows or scroll-bar graphics is optional. Embodiments can be realised in which the scrolling operations are performed in response to user command without the need to display and select scroll direction arrow menu options.

Although the above embodiments have been described with reference to calculating scrolling data sets using the pre-defined steps size 418 to produce the stills or frames 402 to 412, embodiments of the present invention are not limited to such an arrangement. Embodiments can be realised in which each of the stills or frames 402 to 412 represent start and end frames for a scrolling operation and a number of frames are calculated and produced using the sliding window 416 to give effect to a transition between any given pair of start and end frames, that is, a video sequence is generated to represent the transition between the start and end frames. This video sequence can represent an embodiment of a visual asset. It will be appreciated that the smoothness, as perceived by the user, of the scrolling between any given pair of start and end frames will be or, at least can be, significantly greater than the corresponding scrolling using the frames or stills 402 to 412 depending on the step size 418 selected.

The above embodiments have been illustrated with reference to scrolling up and down through the document 414 for the purpose of illustration only and is convenient given the type of text-based document to be scrolled through used to illustrate embodiments of the invention. It will be appreciated that embodiments of the present invention are not limited to scrolling up and down. Embodiments can be realised in which scrolling is effected sideways, that is, left and right. It will be appreciated that such left and right scrolling might be appropriate when viewing a document that is more properly represented horizontally such as, for example, a landscape document showing, for example, a panoramic view. Therefore, the scrolling data sets produced by embodiments of the present invention can also be arranged to produce left and right, or sideways, scrolling together with appropriate navigation data and optional scroll arrow graphics either alone, in the case of a panoramic view or document having a single screen height, or in conjunction with the up and down scrolling navigation data and optional respective scrolling menu graphics in the case of a document that is both wider and higher than the 720×480 or 720×576 pixels of DVD NTSC and DVD PAL/SECAM pixel resolutions, respectively. It will be appreciated that in the latter case, embodiments of the present invention produce 2-dimensional scrolling data sets and allow 2-dimensional scrolling to be realised.

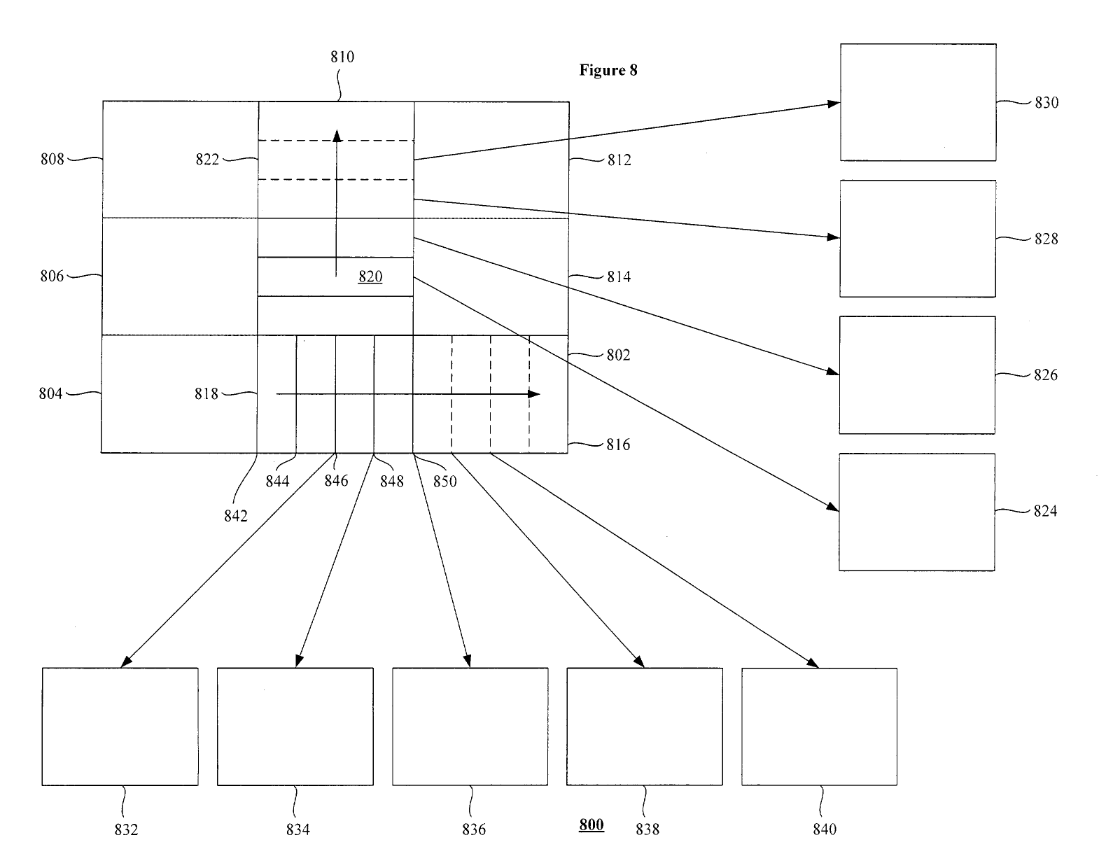

FIG. 8 shows schematically the production 800 of 2-dimensional scrolling data sets. FIG. 8 depicts an initial or original image document 802, which is notionally divided into 9 regions 804 to 822 that can be used to display respective parts of the overall image 802. Although the embodiment will be illustrated using 9 regions, embodiments of the present invention are not limited to such an arrangement. Embodiments can be realised in which scrolling between any predetermined number of regions of a document or asset can be realised.

The visual assets required for vertical scrolling are produced in substantially the same manner as the video sequences, stills or frames 402 to 412 were produced for one-dimensional scrolling. It can be appreciated that a transition from the central region 820 to a central upper region 820 has been shown as requiring the production of a video sequence comprising four stills or frames 824 to 830. The initial frame 824 contains data corresponding to the data contained within the central portion 820. The final frame 830 of the transition contains data corresponding to that contained within the upper central portion 822 of the image 802. The remaining frames 826 and 828 are produced according to a desired step size as a notional window (not shown) traverses the image 802 from the initial position at the central portion 820 to the final position of the upper central portion 822. Again, it will be appreciated that the smoothness or resolution of the scrolling is governed by the step size. The smaller the step size, the greater the number of intermediate visual assets that will be produced. Alternatively, as with the above embodiment, the four stills or frames 824 to 830 might represent intermediate scrolling positions for an overall transition from the central portion 820 to the upper central portion 822 or for a number of transitions en route to the upper central portion 822 from the central portion 820. For each set of adjacent pairs of those intermediate positions such as, for example, positions 826 and 828, a number of intermediate visual assets can be calculated. It will be appreciated that the flowcharts shown in FIGS. 6 and 7 are as applicable to vertical scrolling given an initial or original asset size that is wider than a desired asset size as they are to FIG. 4 in which the desired asset size was the same width or height as the original asset.

FIG. 8 also illustrates the production of horizontal scrolling data sets. In the case of horizontal scrolling, it can be appreciated, again for the purpose of illustration only, that the initial starting position is shown as being the bottom central portion 818 of the overall image 802 and the end position is shown as being the lower right portion 816 of the overall image 802. The illustrated five stills or frames 832 to 840 are produced using corresponding start positions 842 to 850 for a notional window (not shown) as it progressively traverses the original asset 802 according to a respective step size. Again, it will be appreciated that the flowcharts shown in FIGS. 6 and 7 are equally applicable to horizontal scrolling. However, in the flowchart 600 shown in FIG. 6 the asset start and end positions are calculated using W rather than H. In the flowchart 700 shown in FIG. 7, the test performed at step 710 is arranged to determine whether the left arrow of any scroll direction arrow graphics, presented as sub-picture menu items, has been actuated rather than the scroll-up arrow. Again, it will be appreciated that presentation of menu items is optional. Scrolling can be implemented in response to receipt of a corresponding user command without having to present sub-picture menu graphics for selection to effect the scrolling.

It will be appreciated that the complexity of the links between the visual assets increases when video sequences, stills or frames to support two-dimensional scrolling are authored. Rather than having, on average, a pair of links per visual asset, each visual asset will have, on average, at least two pairs of links to respective surrounding assets, assuming scrolling is limited to scrolling in two directions. However, if scrolling is supported in other directions, such as in NE-SW and/or NW-SE directions, the number of links to surrounding or successive assets will, again, be increased.

Furthermore, although the above embodiments have been illustrated using scrolling in mutually orthogonal directions, that is, NS and EW directions, they are not limited to such an arrangement. Embodiments can be realised in which scrolling in other directions, mutually orthogonal or otherwise, can be implemented in addition, or as an alternative, to the NS and EW scrolling illustrated.

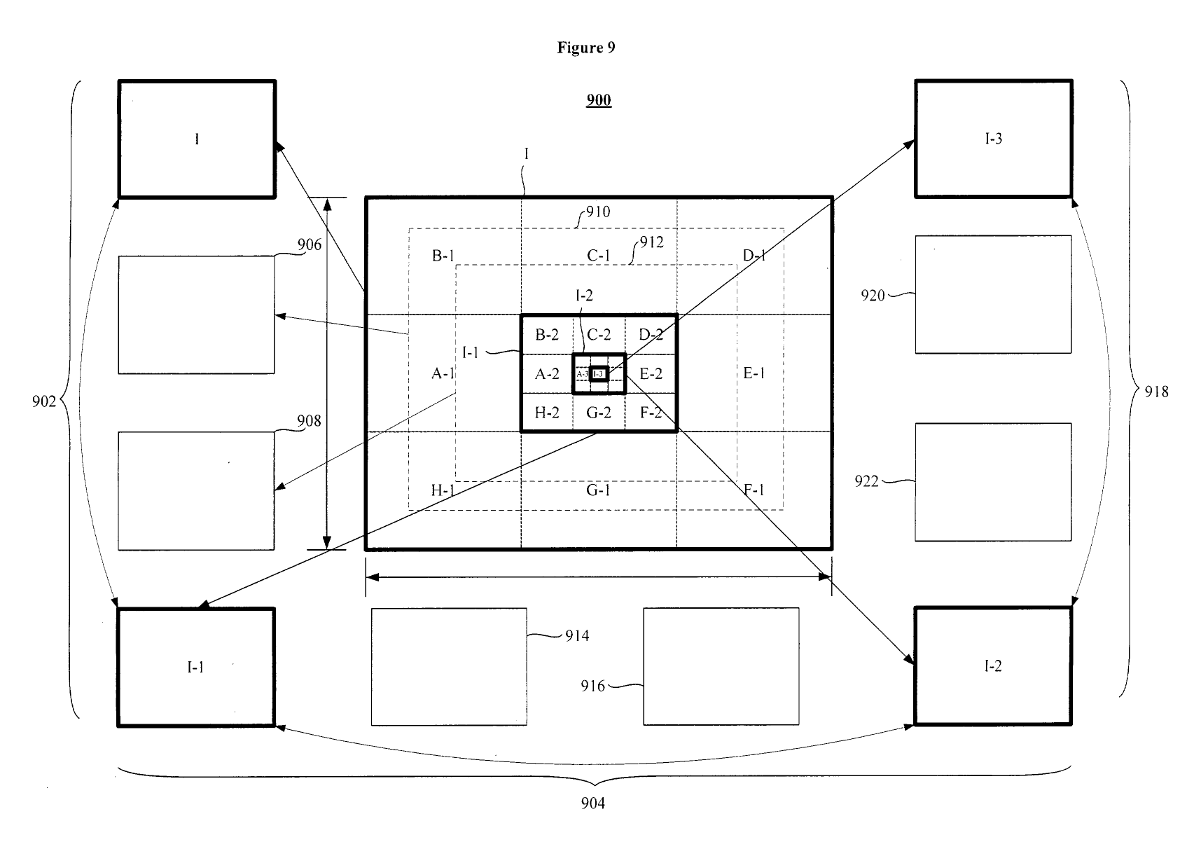

Referring to FIG. 9, there is illustrated a process 900 for producing video sequences that emulate zooming, that is, that give the impression to the user of the DVD that they are controlling zoom-in and zoom-out functions. FIG. 9 comprises an original image I that is notionally divided into a predetermined number of regions. In the illustrated example, the image I has been divided into 9, first level, notional regions that are labelled A-1 to I-1. It will be appreciated that the central portion I-1 is shown as also being sub-divided into 9, second level, notional regions (I, A-1, A-2) to (I, A-1, I-2).

A first level notional region is denoted using the suffix “1”. A second level notional region is denoted using the suffix “2”. Similarly, an Nth level notional region is denoted using the suffix “N”. A notional region, at any level, can be uniquely identified using a respective tuple. For example, the second level notional region A-2 of the first level notional region I-1 can be uniquely identified using the tuple (I, I-1, A-2). By way of a further illustration, the inner most central notional region I-3 can be uniquely referenced or identified using the tuple (I, I-1, I-2, I-3).

Each of the other first-level notional regions A-1 to H-1 can also be sub-divided into 9, second-level, notional regions. Similarly, the central portion I-2 of the first-level notional region I-1 is also shown as being sub divided into 9, third-level, notional regions (I, I-1, I-2, A-3) to (I, I-1, I-2, I-3). Again, each of the other second-level notional regions A-2 to H-2 may also be sub-divided into 9 corresponding third-level notional regions. The number of levels of sub-division of a document or visual asset can be set according to the degree of zooming that is desired. The embodiments of the present invention have been described as having four levels of zooming for the purpose of illustration only.

The levels of each of the notional regions are used to control or zoom-in and zoom-out functions according to embodiments of the present invention. For example, embodiments can be arranged in which a video sequence is generated to reflect zooming between a view of the whole of the image I and a first-level view I-1 of that image I. It will be appreciated that such a video sequence, or, more accurately, such a pair of video sequences, would allow zoom-in and zoom-out functions to be realised to allow the user to view the whole of the first-level image I or a portion I-1 of that image I in greater detail, if so desired. It will be appreciated that the illustrated zooming operations result in 1/9× and 9× views of the document relative to a previous document view for zoom-out and zoom-in respectively.

Although the embodiments have been described with reference to any given level of document view comprising 9 notional regions, embodiments can be realised in which any convenient number of notional regions are used. Furthermore, the number of notional regions used by respective levels of zooming may vary as between regions and also across notional regions at the same level zooming.

It can be appreciated that a pair 902 and 904 of video sequences are illustrated in FIG. 9. The first video sequence 902 of the pair is shown as comprising four frames, that is, a start frame I, an end frame I-1, and two 906 and 908 intermediate or transitional frames. The data for the start frame I is derived from the whole of the original document or image I. The data for the end frame I-1 is derived from the central portion of the initial document I and, preferably, comprises a greater level of detail as compared to the same portion presented at the initial level of image I. The data for the intermediate or transitional frames 906 and 908 is derived from respective transition regions 910 and 912 of the original document 1 respectively and, preferably, from the increased detail view of image I-1. It will be appreciated that the video sequence 902 has been illustrated as comprising four frames for the purposes of illustration only. In practice, the video sequence 902 might contain many more intermediate or transitional frames according to a desired level of smoothness of the zooming between start image I and the end image I-1.

In a similar manner, zooming between document view I-1 and a further document view I-2 is also shown as comprising two frames or transitional images 914 and 916. These transitional images 914 and 916 are derived from respective transitional regions (not shown for the purpose of clarity) in a similar manner to that in which the previously mentioned transitional images 906 and 908 were derived from corresponding transition regions 910 and 912.

Similarly, a still further video sequence 918 illustrating zooming between document views I-2 and I-3, comprising respective transitional images 920 and 922, is also illustrated. As discussed previously, the number of transitional images, derived from respective transition regions, can be set according to a desired smoothness of zooming. Therefore, various video sequences can be generated that illustrate zooming between respective document views.

Preferably, the degree of detail exhibited at each level of zooming is arranged to vary with the levels of zooming. Alternatively, the degree of detail may remain constant between various, or all, levels of zooming.

It will be appreciated that zooming image sequences for zooming operations between the various notional levels of document view can be generated for, and between, each, and any, of the notional regions.

Preferably, when zooming in from one document view to an expanded document view, the resulting, zoomed-in, image is derived from data associated with the central portion of the starting notional regional. For example, when zooming from a document view presented at level I-1, the zoomed-in image is derived from document view I-2. The converse is also preferably true. However, in some embodiments, particularly, when zooming-out from a notional region that is adjacent to, or forms part of, an edge of another, zoomed-out, notional region, all notional regions at that zoomed-out level are presented. For example, zooming-out from document view C-2 does not present a document view that would be derived from notional regions (I, I-1, B-2); (I, I-1, C-2); (I, I-1, D-2); (I, I-1, A-2); (I, I-1, I-2); (I, I-1, E-2); (I, C-1, H-2); (I, C-1, G-2) and (I, C-1, F-2). Instead, the data representing the whole of the notional region I-1 is presented. However, the former can be implemented if desired, that is, the resulting zoomed-out image might be derived from notional regions (I, I-1, B-2); (I, I-1, C-2); (I, I-1, D-2); (I, I-1, A-2); (I, I-1, I-2); (I, I-1, E-2); (I, C-1, H-2); (I, C-1, G-2) and (I, C-1, F-2). However, it will be appreciated that such flexible zooming has storage space consequences that might be unacceptable.

In practice, preferred embodiments realise zooming between two views of a document using a pair of video sequences. The first video sequence represents a zooming operation in one direction and the second video sequence represents a zooming operation in an opposite direction. In effect, one video sequence shows expansion of a document view and the other shows contraction of a document view.

It will be appreciated that the zooming and scrolling operations might be used to allow the user to navigate their way through a map or maze or might represent an interesting way of presenting chapter selections that might be made to jump, that is, scroll or zoom, to a desired chapter of a DVD.

Still further, the above described 1-D and 2-D scrolling can also be used to generate image sequences for moving, that is, scrolling, between the various notional regions of any given level of zooming.

Although the above embodiments have been described with reference to production of graphical elements representing arrows for controlling the scroll and zoom operations, embodiments are not limited to such an arrangement. Embodiments can be realised in which the scrolling or zooming functions are controlled via the IR remote control without the need to select the sub-picture menu options presented in the form of arrows. In such embodiments, the scrolling function may be performed in response to actuation of selected keys, such as, for example, up down and left right arrow keys that are provided on many IR remote controls.

Preferred embodiments use image processing techniques such as, for example, motion blurring when producing the data for frames of video sequences representing scrolling or zooming operations.

Furthermore, embodiments can be realised in which the scrolling or zooming menu graphics are presented and the respective operation is effected substantially immediately without the user having to highlight, or otherwise chose, a menu item and then actuating a further key to give effect to the selection and, hence, the scrolling or zooming operation. It is sufficient in such embodiments that the desired menu graphic is merely highlighted, or otherwise chosen, without the need to invoke a specific “selection” function using a corresponding “selection” key of the remote control. This mode of operation is known as “forced activation”.

Although the above embodiments have been described with reference to deriving data from static or dynamic images or video sequences, embodiments can also be realised in which data for a still or video sequence is derived from a number of video sequences or video streams. Furthermore, a “view” of a document or an asset may comprise the whole or part of that document or asset, either alone, or in conjunction with a view of the whole or part of another document or asset, which, itself, might be a static or dynamic image or a video sequence(s).

For the avoidance of doubt, the phrase “one or more” followed by, for example, a noun comprises “one [noun]” and “two or more [nouns]”, that is, it comprises “at least one [noun]”. Therefore, the phase “one or more video sequences” comprises one video sequence and, similarly, the phrase “one or more original assets” comprises one original asset as well as both extending to “a plurality of video sequences” and “a plurality of original assets” respectively.

The reader's attention is directed to all papers and documents which are filed concurrently with or previous to this specification in connection with this application and which are open to public inspection with this specification, and the contents of all Such papers and documents are incorporated herein by reference.

All of the features disclosed in this specification (including any accompanying claims, abstract and drawings) and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

That which is claimed is:

1. A method of authoring visual content, comprising:
creating one or more video sequences comprising a set of visual assets having data derived from one or more original assets, the one or more video sequences representing a first, progressive, transition between a first view of the one or more original assets and a second view of the one or more original assets.

2. A method as claimed in claim 1, wherein creating one or more video sequences comprises:
deriving the data of the visual assets from the one or more original assets such that the one or more video sequences represent a first, progressive, transition from the first view of the one or more original assets to the second view of the one or more original assets.

3. A method as claimed in claim 1, wherein creating one or more video sequences comprises:
deriving the data of the visual assets from the one or more original assets Such that the one or more video sequences represent a first, progressive, transition from the second view of the one or more original assets to the first view of the one or more original assets.

4. A method as claimed in claim 1, wherein the first, progressive, transition, between the first and second views of the one or more original assets represents a scrolling operation between those views.

5. A method as claimed in claim 1, wherein creating one or more video sequences comprises:
deriving the data of the visual assets from the one or more original assets such that the one or more video sequences of the first, progressive, transition from the first view of the one or more original assets to the second view represents an expansion or contraction of the data of the one or more original assets.

6. A method as claimed in claim 1, further comprising:
creating for the one or more video sequences respective navigation data, responsive to a user command, to cause retrieval and output of the one or more video sequences.

7. A method as claimed in claim 6, wherein creating the navigation data comprises:
creating one or more links between the one or more video sequences and a further video sequence to cause retrieval and output of the further video sequence before or after output of the one or more video sequences.

8. A system for authoring visual content, comprising:
means for creating one or more video sequences comprising a set of visual assets having data derived from one or more original assets; the one or more video sequences representing a first, progressive, transition between a first view of the one or more original assets and a second view of the one or more original assets.

9. A system as claimed in claim 8, wherein the means for creating comprises:
means for deriving the data of the visual assets from the one or more original assets such that the one or more video sequences represent a first, progressive, transition from the first view of the one or more original assets to the second view of the one or more original assets.

10. A system as claimed in claim 8, wherein the means for creating comprises:
means for deriving the data of the visual assets from the one or more original assets such that the one or more video sequences represent a first, progressive, transition from the second view of the one or more original assets to the first view of the one or more original assets.

11. A system as claimed in claim 8, wherein the first, progressive, transition, between the first and second views of the one or more original assets represents a scrolling operation between those views.

12. A system as claimed in claim 8, wherein the means for creating comprises:
means for deriving the data of the visual assets from the one or more original assets such that the one or more video sequences of the first, progressive, transition from the first view of the one or more original assets to the second view represent an expansion or contraction of the data of the one or more original assets.

13. A system as claimed in claim 8, further comprising:
means for creating for the one or more video sequences respective navigation data, responsive to a user command, to cause retrieval and output of the one or more video sequences.

14. A system as claimed in claim 13, wherein the means for creating the navigation data comprises:
means for creating one or more links between the one or more video sequences and a further video sequence to cause retrieval and output of the further video sequence before or after output of the one or more video sequences.

15. A computer program product, comprising:
a computer readable program medium having computer readable program code embodied therein, the computer readable program code comprising:
data representing one or more video sequences comprising a set of visual assets having data derived from one or more original assets; the one or more video sequences representing a first, progressive, transition between a first view of the one or more original assets and a second view of the one or more original assets.

16. A computer program product as claimed in claim 15, wherein the data representing the one or more video sequences represents a scrolling action between the first and second views of the one or more original assets.

17. A computer program product as claimed in claim 15, wherein the data representing the one or more video sequences represents a scrolling action between first and second views of a number of temporally successive images.

18. A computer program product as claimed in claim 15, wherein the data representing the one or more video sequences represents a scrolling action between first and second views of a dynamic image or one or more video sequences.

19. A computer program product as claimed in claim 15, wherein the data representing the one or more video sequences represents a zooming action between the first and second views of the one or more original assets.

20. A computer program product as claimed in claim 15, wherein the data representing the one or more video sequences represents a zooming action between first and second views of a number of temporally successive images.

21. A computer program product as claimed in claim 15, wherein the data representing the one or more video sequences represents a zooming action between first and second views of a dynamic image or one or more video sequences.

22. A computer program product as claimed in claim 15, wherein the one or more original assets comprises at least one static image.

23. A computer program product as claimed in claim 15, wherein the one or more original assets comprises a sequence of temporally successive static images.

24. A computer program product as claimed in claim 15, wherein the one or more original assets comprises a dynamic image or at least one video stream or sequence.

25. A computer program product as claimed in claim 15, wherein the computer readable program medium is an optical medium.

26. A computer program product as claimed in claim 25, wherein the optical medium is a DVD product.

27. A computer program product as claimed in claim 15, wherein the computer readable program medium is a magnetic medium.

28. A computer program product as claimed in claim 27, wherein the computer readable program medium is a digital linear tape.

29. A method for authoring optical medium data, comprising:
producing, from data representing a static or dynamic visual asset, a set of visual assets in which each visual asset of the set comprises data unique to that asset and data common to that asset and at least one other visual asset of the set; each visual asset of the set having respective defined dimensions.

30. A method as claimed in claim 29, wherein producing the set of visual assets comprises:
progressively traversing the static visual assets to copy data, from the static visual asset, to form respective visual assets of the set.

31. A method as claimed in claim 30, wherein traversing the static visual assets comprises:
defining a predeterminable step size, less than at least one of the respective defined dimensions; and
traversing the static visual asset according to that predeterminable step size.

32. A method as claimed in claim 29, further comprising:
creating, for each visual asset in the set, associated asset display control data comprising data representing at least one selectable graphical element and at least one link, associated with the selectable graphical element, to another visual asset of the set of visual assets.

33. A method as claimed in claim 32, wherein creating associated asset display control data comprises:
creating, for selected or all visual assets of the set of visual assets, associated asset display control data comprising data representing at least a pair of selectable graphical elements and data representing at least a pair of links, associated with respective ones of the pair of selectable graphical elements, to a preceding visual asset and a succeeding visual asset of the set of visual assets.

34. A method as claimed in claim 29, wherein at least one of the dimensions of the static visual asset exceeds at least one of the defined dimensions of at least one of the visual assets of the set of visual assets.

35. A method as claimed in claim 34, wherein the dimensions of the static visual asset exceed two defined dimensions of at least one of the visual assets of the set of visual assets.

36. A method as claimed in claim 29, wherein producing the set of visual assets comprises:
progressively traversing, in at least two different directions, the static visual asset to copy data, from the static visual asset, to form respective visual assets of the set.

37. A method as claimed in claim 29, wherein producing the set of visual assets comprises:
progressively traversing, in at least two orthogonal directions, the static visual asset to copy data, from the static visual asset, to form respective visual assets of the set.

38. A data processing system for authoring optical medium data, comprising:
means for producing, from data representing a static or dynamic visual asset, a set of visual assets in which each visual asset of the set comprises data unique to that asset and data common to that asset and at least one other visual asset of the set, each visual asset of the set having respective defined dimensions.

39. A data processing system as claimed in claim 40, wherein the means for producing the set of visual assets comprises means for progressively traversing the static visual asset to copy data, from the static visual asset, to form respective visual assets of the set.

40. A data processing system as claimed in claim 39, wherein the means for traversing comprises:
means for defining a predeterminable step size, less than at least one of the respective defined dimensions, and traversing the static visual asset according to that predeterminable step size.

41. A data processing system as claimed in claim 38, further comprising:
means for creating, for each visual asset in the set, associated asset display control data comprising data representing at least one selectable graphical element and at least one link, associated with the selectable graphical element, to another visual asset of the set of visual assets.

42. A data processing system as claimed in claim 41, wherein the means for creating comprises:
means for creating, for selected or all visual assets of the set of visual assets, associated asset display control data comprising data representing at least a pair of selectable graphical elements and data representing at least a pair of links, associated with respective ones of the pair of selectable graphical elements, to a preceding visual asset and a succeeding visual asset of the set of visual assets.

43. A data processing system as claimed in claim 38, wherein at least one of the dimensions of the static visual asset exceeds at least one of the defined dimensions of at least one of the visual assets of the set of visual assets.

44. A data processing system as claimed in claim 43, wherein the dimensions of the static visual asset exceed two defined dimensions of the visual assets of the set of visual assets.

45. A data processing system as claimed in claim 38, wherein the means for producing the set of visual assets comprises:
means for progressively traversing, in at least two different directions, the static visual asset to copy data, from the static visual asset, to form respective visual assets of the set.

46. A data processing system as claimed in claim 38, wherein the means for producing the set of visual assets comprises means for progressively traversing, in at least two orthogonal directions, the static visual asset to copy data, from the static visual asset, to form respective visual assets of the set.

47. A DVD product, comprising:
a DVD that contains data thereon, the data representing a video sequence comprising a set of visual assets; the visual assets having been derived from at least one original visual asset such that at least a pair of successive visual assets of the set of visual assets comprise respective unique data and data common to the pair of successive visual assets thereby allowing a scrolling effect to be emulated when the pair of assets are successively displayed.

48. A method of manufacturing a DVD product, comprising:
creating a data carrier comprising data representing one or more video sequences comprising a set of visual assets having data derived from one or more original assets, the one or more video sequences representing a first, progressive, transition between a first view of the one or more original assets and a second view of the one or more original assets.

49. A method of manufacturing a DVD product, comprising:
creating a data carrier comprising data representing a static or dynamic visual asset, a set of visual assets in which each visual asset of the set comprises data unique to that asset and data common to that asset and at least one other visual asset of the set; each visual asset of the set having respective defined dimensions.

50. A computer program product for authoring optical medium data, comprising:
a computer readable program medium having computer readable program code embodied therein, the computer readable program code comprising:
computer readable program code configured to produce, from data representing a static or dynamic visual asset, a set of visual assets in which each visual asset of the set comprises data unique to that asset and data common to that asset and at least one other visual asset of the set; each visual asset of the set having respective defined dimensions.

51. A computer program product as claimed in claim 50, wherein the computer readable program code configured to produce the set of visual assets comprises:
computer readable program code configured to progressively traverse the static visual assets to copy data, from the static visual asset, to form respective visual assets of the set.

52. A computer program product as claimed in claim 51, wherein the computer readable program code configured to traverse the static visual assets comprises:
computer readable program code configured to define a predeterminable step size, less than at least one of the respective defined dimensions; and
computer readable program code configured to traverse the static visual asset according to that predeterminable step size.

53. A computer program product as claimed in claim 50, further comprising:
computer readable program code configured to create, for each visual asset in the set, associated asset display control data comprising data representing at least one selectable graphical element and at least one link, associated with the selectable graphical element, to another visual asset of the set of visual assets.

54. A computer program product as claimed in claim 53, wherein the computer readable program code configured to create associated asset display control data comprises:
computer readable program code configured to create, for selected or all visual assets of the set of visual assets, associated asset display control data comprising data representing at least a pair of selectable graphical elements and data representing at least a pair of links, associated with respective ones of the pair of selectable graphical elements, to a preceding visual asset and a succeeding visual asset of the set of visual assets.

55. A computer program product as claimed in claim 50, wherein at least one of the dimensions of the static visual asset exceeds at least one of the defined dimensions of at least one of the visual assets of the set of visual assets.

56. A computer program product as claimed in claim 55, wherein the dimensions of the static visual asset exceed two defined dimensions of at least one of the visual assets of the set of visual assets.

57. A computer program product as claimed in claim 50, wherein the computer readable program code configured to produc the set of visual assets comprises:
computer readable program code configured to progressively traverse, in at least two different directions, the static visual asset to copy data, from the static visual asset, to form respective visual assets of the set.

58. A computer program product as claimed in claim 50, wherein the computer readable program code configured to produce the set of visual assets comprises:
computer readable program code configured to progressively traverse, in at least two orthogonal directions, the static visual asset to copy data, from the static visual asset, to form respective visual assets of the set.
